(19) United States
(12) Patent Application Publication
(10) Pub. No.: US 2007/0147255 A1
(43) Pub. Date: Jun. 28, 2007

(54) Routing in wireless mesh networks

(76) Inventor: Ozgur Oyman, Palo Alto, CA (US)

Correspondence Address: INTEL CORPORATION;c/o INTELLEVATE, LLC, P.O. BOX 52050, MINNEAPOLIS, MN, 55402, US

(21) Appl. No.: 11/318,206

(22) Filed: Dec. 23, 2005

(51) Int. Cl. H04J 3/14

(52) U.S. Cl. 370/238

(57) ABSTRACT

A method, apparatus and system for communicating in a wireless mesh network may entail using a Viterbi routing algorithm to determine a multi-hop path between a source node and a destination node having a lowest cost metric. In one example, the cost metric may be inversely proportional to the achievable transmission rate in the links of each potential multi-hop path. A next hop node in two or more potential multi-hop paths for routing a wireless communication to a destination node may be determined by each node based on the multi-hop path having a lowest cost metric associated with communicating to the destination node. Other embodiments and variations are described in the detailed description.

### BACKGROUND OF THE INVENTION

It is becoming increasingly attractive to use nodes in a wireless network as relaying points to extend range and/or reduce costs of the wireless network. For example, in a wireless wide area network (WWAN) or wireless metropolitan area network (WMAN) that requires deployment of distributed base stations across large areas, the base stations need to be connected to a core network and/or each other via some type of backhaul. In conventional networks, the backhaul has typically consisted of wired connections. However, a wireless backhaul, rather than, or in some combination with, a wired backhaul is being increasingly considered to ease deployment and reduce costs associated with these networks.

A type of network which uses wireless stations to relay signals between a source and destination are colloquially referred to as mesh networks. In mesh networks, wireless network nodes may form a “mesh” of paths for which a communication may travel to reach its destination. The use of a wireless mesh network as a wireless backhaul has become the subject of much focus and there are ongoing efforts to increase the efficiency of transmissions through wireless mesh networks.

### BRIEF DESCRIPTION OF THE DRAWING

Aspects, features and advantages of embodiments of the present invention will become apparent from the following description of the invention in reference to the appended drawing in which like numerals denote like elements and in which:

FIGS. 1 and 2 are block diagrams illustrating an arrangement of wireless nodes in a wireless mesh network according to various embodiments of the present invention;

FIG. 3 is a flow diagram showing a Viterbi-based algorithm for routing transmissions through a wireless mesh network according to one or more embodiments of the present invention;

FIG. 4 is a block diagram illustrating the arrangement of FIG. 2 with an example calculation of cost metrics and routing updates according to various embodiments of the present invention; and

FIG. 5 is a block diagram showing an example wireless apparatus according to various aspects of the invention.

### DETAILED DESCRIPTION OF THE INVENTION

While the following detailed description may describe example embodiments of the present invention in relation to WMANs, the inventive embodiments are not limited thereto and can be applied to other types of wireless networks where similar advantages may be obtained. Such networks for which inventive embodiments may be applicable specifically include, wireless personal area networks (WPANs), wireless local area networks (WLANs), WWANs such as cellular networks and/or combinations of any of these networks. Further, inventive embodiments may be discussed in reference to wireless networks utilizing Orthogonal Frequency Division Multiplexing (OFDM) modulation. However, the embodiments of present invention are not limited thereto and, for example, can be implemented using other modulation and/or coding schemes where suitably applicable.

The following inventive embodiments may be used in a variety of applications including transmitters and receivers of a radio system. Radio systems specifically included within the scope of the present invention include, but are not limited to, network interface cards (NICs), network adaptors, mobile stations, base stations, access points (APs), hybrid coordinators (HCs), gateways, bridges, hubs and routers. Further, the radio systems within the scope of the invention may include cellular radiotelephone systems, satellite systems, personal communication systems (PCS), two-way radio systems and two-way pagers as well as computing devices including radio systems such as personal computers (PCs) and related peripherals, personal digital assistants (PDAs), personal computing accessories and all existing and future arising systems which may be related in nature and to which the principles of the inventive embodiments could be suitably applied.

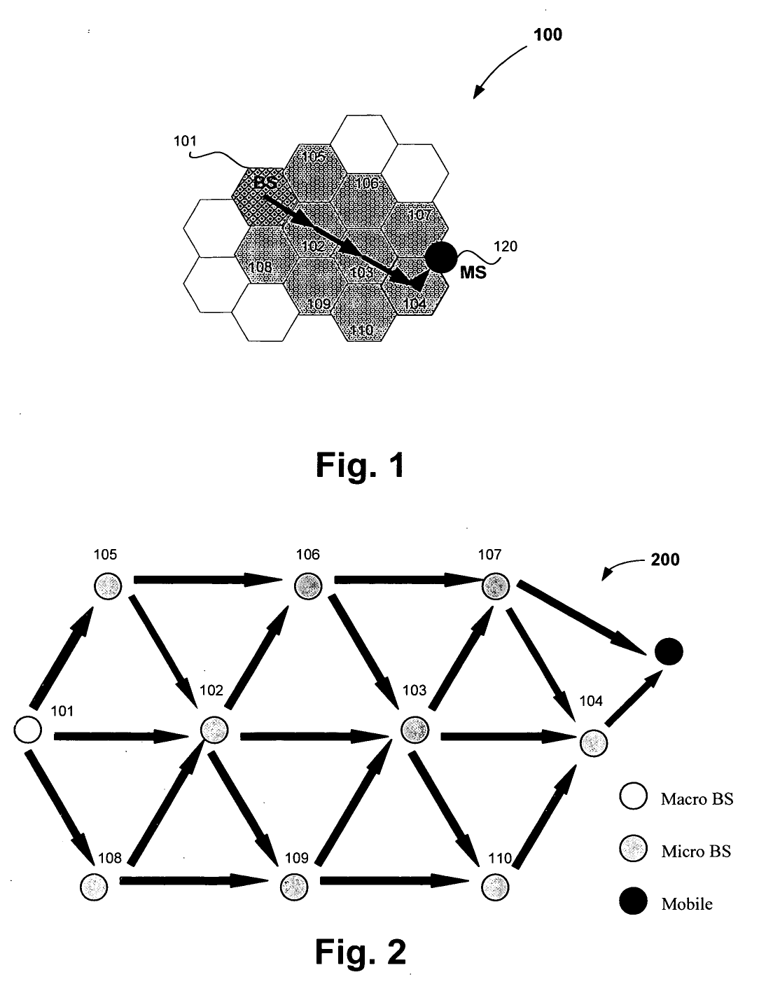

Turning to FIG. 1, a wireless communication network 100 according to various inventive embodiments may be any system having devices capable of transmitting and/or receiving information via over-the-air (OTA) radio frequency (RF) links. For example in one embodiment, network 100 may include a plurality of wireless nodes 101-110 (and other undesignated nodes) to communicate or relay messages to and/or from one or more fixed or mobile devices, such as mobile station 120. It should be recognized that FIG. 1 represents an example topology where each node 101-110 would be located at a center of each illustrated polynomial. Each hexagon in the illustrated pattern is intended to generally represent a spatial or “cellular” range for radio link coverage of each node in a region of nodes that form mesh network 100. Additional unreferenced cells (white hexagons) also include nodes which are not relevant to the specific example.

In certain embodiments, the wireless nodes in network 100 may be devices which communicate using wireless protocols and/or techniques compatible with one or more of the Institute of Electrical and Electronics Engineers (IEEE) various wireless standards including for example, 802.11 (a), (b), (g) and/or (n) standards for WLANs, 802.15 standards for WPANs, and/or 802.16 standards for WMANs, although the inventive embodiments are not limited in this respect.

Using existing 802.11 medium access control (MAC) specifications for ad-hoc network configurations, a broadcast operation over network 100 may be performed either by unicast-forwarding of a broadcast message or by broadcast-forwarding of the broadcast message. In unicast-forwarding the broadcast message will be unicasted to each neighbor individually and each neighbor in turn will forward the broadcast message to all its neighbors by doing multiple unicast transmissions until the message is eventually broadcasted to all nodes or mesh points. In broadcast-forwarding the broadcast message may be broadcasted to all neighbors using a unique broadcast destination address (for example, a MAC address containing all 1s). Each neighbor node receiving such a message will also broadcast the message and so on until all mesh nodes have received the broadcast message.

However, significant transmission redundancy overhead occurs when using either of these conventional methods, because all mesh nodes will transmit the broadcast message, when in fact, only a few mesh nodes may be needed to get the message from point A to point B, for example, between base station 101 and mobile station 120. This type of redundancy is unacceptable in high throughput infrastructures such as wireless backhaul arrangements for broadband wireless networks.

Thus techniques to specifically route transmissions through a wireless mesh network are desirable. Further, to promote increased efficiency and/or reliability, mesh routing techniques should consider the channel characteristics between mesh nodes in choosing a path to route transmissions. This is most suitable where the channel between nodes has relatively slow varying or fading characteristics such as between fixed wireless stations. By way of example, referring to FIG. 1, there may be various different levels of channel qualities in the links between each respective node. Accordingly, routing transmissions between the source node (e.g., base station 101) and the destination node (e.g., mobile station 120) may not only consider the fewest number of hops needed (shown by black arrows between nodes 102, 103 and 104) to reach the destination, but may also consider the quality of air links in potential paths between these nodes and adjacent nodes 105-110 in a lattice or trellis of nodes between the source and destination node.

In one non-limiting example implementation, one or more of nodes in network 100 (e.g., node 101) may be a wireless transceiver that is connected to a core network, such as an Internet protocol (IP) network, via a physical wired connection (e.g., electrical or fiber optic connection). This type of station is referred to herein as a “macro” base station (BS). Additionally, in certain embodiments, one or more of nodes (e.g., nodes 102-110) in network 100 may be wireless transceivers that are not connected to a core network by electrical or wires or optical cables but rather provide a wireless backhaul as mentioned previously. Typically, the transmit power and antenna heights of these wireless transceivers are less than that for the macro BS. These types of stations may be fixed radio relay nodes which are sometimes referred to as “micro” or “pico” base stations (depending on the size of their coverage area), although the inventive embodiments are not limited in this respect. Thus in certain embodiments of wireless mesh network 100, micro base stations may provide connectivity to each other and/or to macro base stations via wireless links using 802.16 and/or 802.11 protocols.

Consider a downlink scenario (although the inventive embodiments may be applied in both uplink and downlink scenarios) where a packet initiated by macro base station 101 needs to be routed to mobile station 120. In this embodiment, it is assumed that only one relay node transmits to its adjacent relay node in a given time/frequency resource in a multi-hop fashion. The search for a routing path is limited to an initial trellis of nodes 102-110 between base station 101 and destination 120. It is assumed that the optimal route lies on a multi-hop path within this trellis of relay nodes 102-110 and paths between non-adjacent nodes may be ignored. This is a reasonable assumption as the path loss between non-adjacent cells is significantly higher than between adjacent cells.

This simplification reduces the general routing problem of finding a minimum cost path over a weighted graph (which can be solved using the complicated Dijkstra algorithm) to a simpler layered network routing problem that can be solved with the Viterbi algorithm. The Viterbi algorithm, named after its developer Andrew Viterbi, is a dynamic program algorithm for finding the most likely sequence of hidden states, known as a Viterbi path, that results in a sequence of observed events. The Viterbi algorithm has long been used in error-correction schemes for communication links, with particular application in decoding convolutional codes used in code division multiple access (CDMA) and other communication systems. The embodiments of the present invention are believed to be the first to utilize the Viterbi algorithm for routing communications in a wireless network.

A trellis diagram 200 of the limited band of nodes 101-120 participating in above scenario is shown in FIG. 2. While the shortest path (e.g., between nodes 102, 103 and 104) is preferable for minimizing the total number of hops, if any of the links in this path experience significant channel fade, it may be desirable to increase the number of hops and pick an alternate path that includes any of adjacent nodes 105, 106, 107, 108, 109 or 110, in order to maximize reliability and/or end-to end throughput. It should be noted that the routing techniques of this inventive embodiment may work independently of choosing of the specific pattern of nodes in trellis diagram 200. For example, the number of nodes in the limited path could be expanded or reduced at the discretion of a designer. Any given choice will result in a layered network routing scheme that can be optimized using the Viterbi-based routing algorithm.

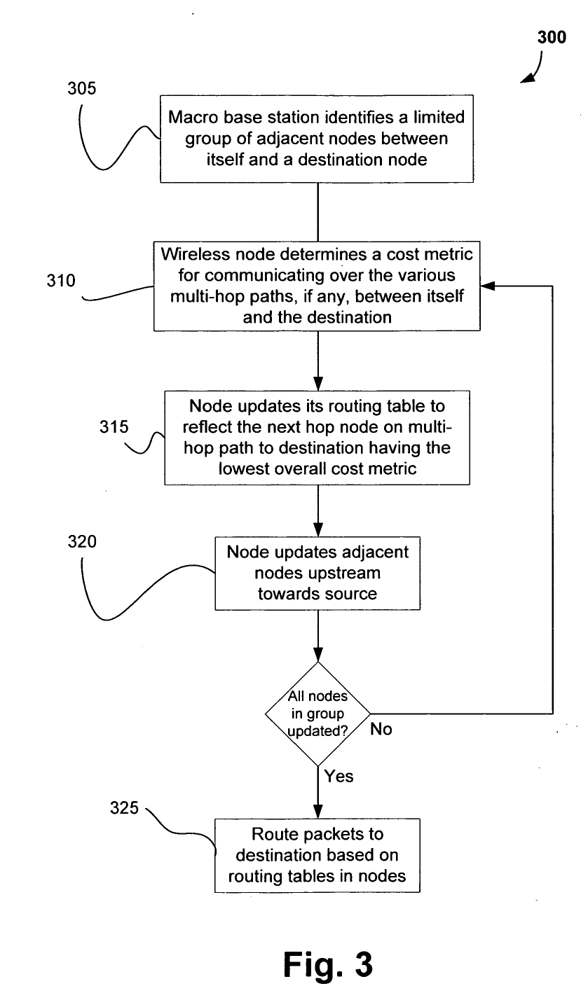

Turning to FIG. 3, a Viterbi-based routing algorithm 300 for routing transmissions in a multi-hop wireless mesh network may include the identifying 305 a limited band of adjacent nodes between a source node and destination node, and determining 315 a next hop node for communicating to the destination having the lowest total cost metric. Once each node in the group has updated 315 its routing table identifying the next adjacent hop on the lowest cost path, packets from the source may be routed to the destination based on the routing tables in the selected group of nodes.

Identifying 305 the limited band of adjacent nodes may be performed in a variety of manners. Typically all the micro base stations and/or mobile stations within a regional coverage area of the macro BS would be considered. Based on the location of the mobile station, the macro BS can determine a limited set of nodes for potential use and inform the set of nodes that will be considered for route construction.

Each node in the identified group may determine 310 a total cost metric for communicating over the various potential multi-hop paths using adjacent nodes, if any, between itself and the destination. For example, each node can determine the cost metric associated with communicating over the links between itself and the destination via any combination of multi-hop paths through its adjacent neighbor nodes. Determining the cost metric can be performed for any particular type of metric desired. In one embodiment of the present invention, the cost metric may relate to the available rate or time a transmission may experience in a particular link, although any desired metric could be used. The channel quality for each link in the trellis can be determined, for example based on a feedback signal or passive scanning of beacons, depending on the underlying network technology. A throughput rate can be assessed at each node (e.g., 101-110; FIGS. 1-2) for each link to other adjacent nodes in the trellis.

For example, consider an N-hop path such that the transmission time at hop n is tₙ seconds and the transmission rate at hop n is Rₙ bits/second. If a transmitted message contains B bits of information and is transmitted in multiple hops over T seconds, then the end-to-end throughput R can be calculated using Equation 1 below:

$$T = {\sum }_{n = 1}^{N} {t}_{n} = {\sum }_{n = 1}^{N} \frac{B}{{R}_{n}} \to R = {( {\sum }_{n = 1}^{N} \frac{1}{{R}_{n}} )}^{- 1} \qquad ( 1 )$$

where Rₙ is computed as a function of the instantaneous received signal-to-noise ratio SNRₙ, which depends on the knowledge of the channel realization over the n^{th} hop.

Due to the stationary nature of fixed relay nodes (e.g., nodes 101-110; FIG. 1), it is expected that the channels experienced between fixed wireless hops will be slow-fading (except for the last hop if a mobile station is involved) and each node will be able to track its own transmit/receive channels. The goal of the routing algorithm is to find the multi-hop path that maximizes R (or minimizes T). Equivalently, denoting the cost of each link as Cₙ₌1/Rₙ, the throughput-maximizing path is the path that minimizes total cost.

Each branch on the trellis shown in FIG. 2 may thus be assigned a cost metric, for example, using the following equation

$$cost\_of \_link = \frac{1}{rate\_of \_link} \qquad ( 2 )$$

With this setup, the optimal multi-hop route can readily be determined using the Viterbi-based routing algorithm.

Once a node determines the cost links associated with the multi-hop paths using each of its adjacent downstream nodes in the limited group, the node may update 315 its internal routing table to identify the next hop node on the lowest cost (or “optimal”) path to the destination. In certain embodiments, the total cost metric of communicating between the present node and the destination on the lowest cost path, may also be recorded in the routing table. This information may be passed 320, automatically or on request, to adjacent nodes upstream so they may repeat the process. Once the nodes in the identified group have been updated, the packets may be transmitted by the source and routed 325 along the optimal path based on the routing tables within each node.

The Viterbi-based routing algorithm of the inventive embodiments is a special case of destination-sequenced-distance-vector (DSDV) routing algorithm in the sense that the route selection is performed in a distributed (i.e., node by node) fashion. This differs from a centralized link-state algorithm (such as Dijkstra) which assumes that global information about connectivity and link costs is available at each node.

Due to the layered nature of the micro-cellular infrastructures described above, the distributed implementation of the route selection algorithm incurs much less overhead cost than that for arbitrary ad hoc networks. Furthermore, routing over this kind of infrastructure network with fixed network topology ensures timely updates of route changes and avoids routing loops. (A primary cause of formation of routing loops is that nodes choose their next hops in a completely distributed fashion based on information which can possibly be incorrect to asynchronous reception or unexpected changes in network topology.)

According to aspects of the inventive embodiments, routing updates are easier to initiate due to the stable and low-mobility links between fixed wireless stations and there is no need for complex packet exchanges. These are all improvements over DSDV for ad hoc networks, which have excessive overhead associated with period or triggered updates.

The following is representative of pseudo-code that may be used to implement the Viterbi-based routing algorithm in a layered network, for example the network of FIG. 1 as represented by trellis 200 of FIG. 2. Each node 101-120 in FIG. 2 represents a transceiver station (BS or MS). For the downlink routing problem illustrated in FIG. 2, the routing algorithm, according to one embodiment, computes the minimum cost (or optimal) path in a distributed and computationally efficient way in a backwards fashion (e.g., starting at node 110 back to base station 101). The algorithm may use the following recursive procedure: (i) at each trellis stage, the deciding node only retains the best (lowest cost) “surviving” path to the destination and ignores or eliminates the rest of the potential paths between that node and the destination; and (ii) the deciding node updates its cost metric based on the surviving path.

The minimum cost path (starting from MS 120) may be computed using the following pseudo-code:

1. Generate random channels for each link (branch arrows in FIG. 2 represent each link) and compute the branch cost metrics according to equation (2) above.

2. Let the set Φ(k) contain the sequence of nodes from node k to the MS with the lowest cost (to be referred as the optimal route for node k) and the metric dₖ denotes the total cost of sending data from node k to the MS based on the route specified by Φ(k).

3. Initialize cost at MS as zero; i.e. d_{MS} =0 and Φ(MS)=[ ]=empty.

4. Repeat the following procedure for all nodes: Let Ω(k) be the set of nodes that can receive data from node k∈K (K is the set of all nodes on the trellis). Once all nodes in Ω(k) have their optimal routes Φ(i) and cost metrics dᵢ, i ∈Ω(k), computed, assign the cost metric of node k as

$${d}_{k} = {min}_{i ∈ Ω ( k )} \{ {d}_{i} + {c}_{k \to i} \} ,$$

where c_{k→i} is the branch metric for the link from node k to node i∈Ω(k). Assign

$$Φ ( k ) as Φ ( k ) \begin{matrix}= [ k & Φ ( {i}_{best} ) ] , where {i}_{best} = arg {min}_{i ∈ Ω ( k )} \{ {d}_{i} + {c}_{k \to i} \} .\end{matrix}$$

Thus, starting at mobile station 120, the routing algorithm according to the inventive embodiments may sequentially compute the cost metrics and optimal routes at each node according to the described procedure. The set of branches (wireless links) that yield the lowest cost at macro base station 101 (i.e. the set Φ(Macro_BS) in the above pseudo-code) is selected as the optimal multi-hop path and used for transmitting 320 packets to destination 120. After the algorithm is complete, the individual nodes may now self route the packets destined for mobile station 120 along the optimal path. Packets may be transmitted between nodes of the network by using routing tables stored at each node.

In one embodiment, each node may include a routing table that, for example, lists all available destinations as well as a cost metric and next hop associated with each destination. In one example implementation, each node may estimate the usable throughput of the potential next-hop nodes over the layered infrastructure by requesting the cost metric of each potential next hop. The provided cost metric, in addition to the cost metric determined for communicating over the channel with the adjacent node itself, may be used to update the node's routing table with the optimal next hop and total cost metric of communicating to the destination thus far.

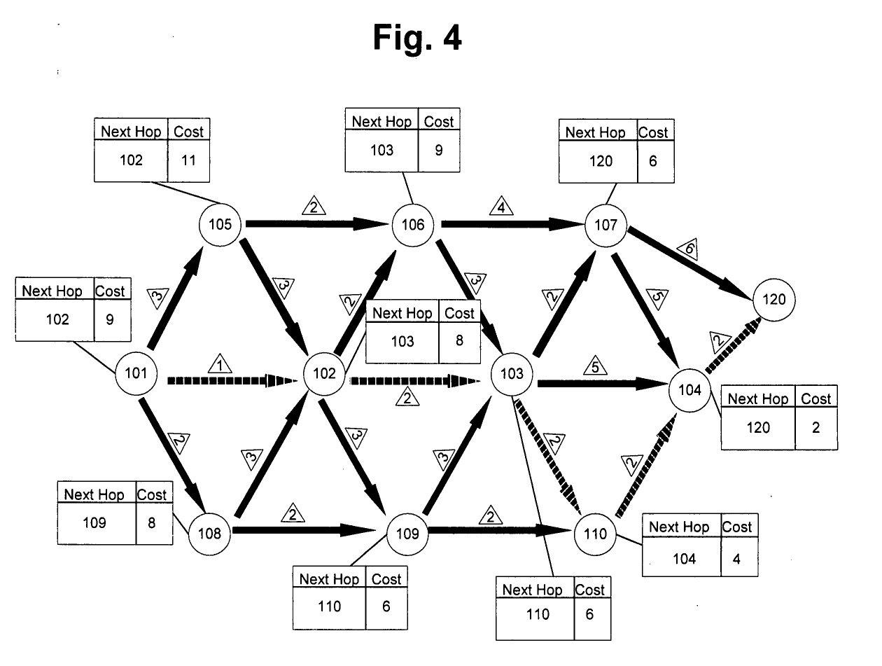

An instantiation of the algorithm is shown in FIG. 4. Each branch (link) between nodes is labeled with example costs denoted within triangles and nodes 101-120 (source=101 and destination=120) are shown along with their routing tables. As can be seen in this simplified example, the optimal multi-hop path (i.e., lowest cost) is the node path 101→102→103→110→104→120, with a total cost (as shown in the routing table of node 101), of nine. Consequently, while the shortest path may only be four hops between source 101 and destination 120, the lowest cost and/or most reliable path has five hops (designated by dashed arrows). In the event there two or more multi-hop paths have the same lowest cost, the algorithm may choose the path with the fewest number of hops, or, if two or more have the same number of hops as well, the algorithm may randomly choose the optimal path to use.

In the case where mobile station 120 desires a route to macro base station 101 (i.e., uplink route) for which an optimal route has not already been established, in one embodiment, mobile station 120 may broadcast a route request (RREQ) packet or similar query communication across the network.

Upon receipt of a RREQ packet, macro base station 101 may search its location controller (LC), which may contain information regarding the locality and neighborhood of each mobile station and/or micro base station, to determine a group of nodes that may participate in the multi-hop communication. This information may be sent using a route reply (RREP) message or similar advertisement. As the RREP propagates back to mobile station 120, the nodes may set up forward pointers to their neighboring nodes, creating a trellis for the layered infrastructure network similar to the one illustrated in FIG. 2 for the downlink scenario.

Once mobile station 120 receives the RREP, it may use the information to update its routing. For example, if the RREP discloses a routing path that has a greater number of hops or the same number of hops with a smaller cost, it may update its routing information for messages to macro base station 101 and begin using the updated route for transmissions.

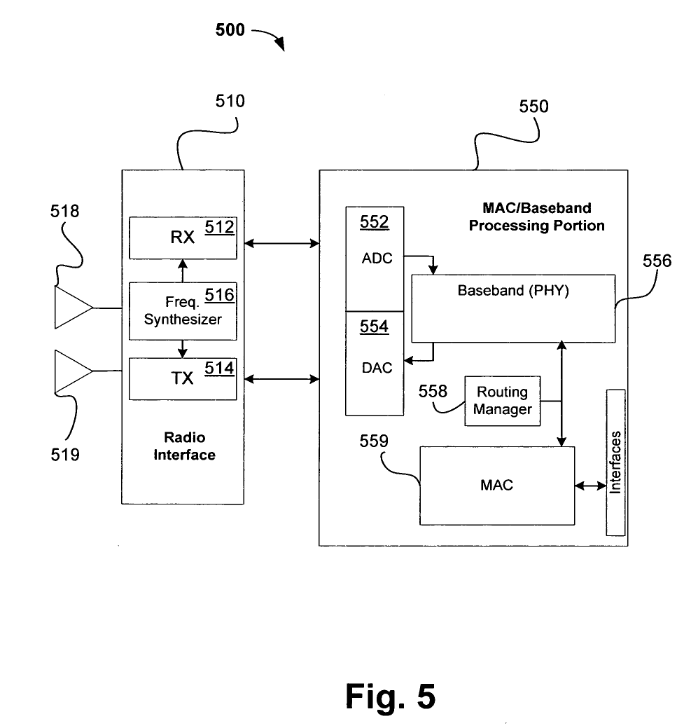

Referring to FIG. 5, an apparatus 500 for use in a wireless network may include a processing circuit 550 including logic (e.g., circuitry, processor(s) and software, or combination thereof) to route communications as described in one or more of the processes above. In certain embodiments, apparatus 500 may generally include a radio frequency (RF) interface 510 and a baseband and MAC processor portion 550.

In one example embodiment, RF interface 510 may be any component or combination of components adapted to send and receive modulated signals (e.g., OFDM) although the inventive embodiments are not limited to any particular modulation scheme. RF interface 510 may include, for example, a receiver 512, a transmitter 514 and a frequency synthesizer 516. Interface 510 may also include bias controls, a crystal oscillator and/or one or more antennas 518, 519 if desired. Furthermore, RF interface 510 may alternatively or additionally use external voltage-controlled oscillators (VCOs), surface acoustic wave filters, intermediate frequency (IF) filters and/or radio frequency (RF) filters as desired. Various RF interface designs and their operation are known in the art and the description for configuration thereof is therefore omitted.

In some embodiments interface 510 may be configured to provide OTA link access which is compatible with one or more of the IEEE standards for WPANs, WLANs, WMANs or WWANs, although the embodiments are not limited in this respect.

Processing portion 550 may communicate/cooperate with RF interface 510 to process receive/transmit signals and may include, by way of example only, an analog-to-digital converter 552 for digitizing received signals, a digital-to-analog converter 554 for up converting signals for carrier wave transmission, and a baseband processor 556 for physical (PHY) link layer processing of respective receive/transmit signals. Processing portion 550 may also include or be comprised of a processing circuit 559 for MAC/data link layer processing.

In certain embodiments of the present invention, a mesh routing manager 558 may be included in processing portion 550 and which may function to determine routing and control mesh node addressing as described previously. Alternatively or in addition, PHY circuit 556 or MAC processor 559 may share processing for certain of these functions or perform these processes independently. MAC and PHY processing may also be integrated into a single circuit if desired.

Apparatus 500 may be, for example, a mobile station, a wireless base station or AP, a hybrid coordinator (HC), a wireless router and/or a network adaptor for electronic devices. Accordingly, the previously described functions and/or specific configurations of apparatus 500 could be included or omitted as suitably desired.

Embodiments of apparatus 500 may be implemented using single input single output (SISO) architectures. However, as shown in FIG. 5, certain implementations may use multiple input multiple output (MIMO), multiple input single output (MISO) or single input multiple output (SIMO) architectures having multiple antennas (e.g., 518, 519) for transmission and/or reception. Further, embodiments of the invention may utilize multi-carrier code division multiplexing (MC-CDMA) multi-carrier direct sequence code division multiplexing (MC-DS-CDMA) for OTA link access or any other existing or future arising modulation or multiplexing scheme compatible with the features of the inventive embodiments.

The components and features of apparatus 500 may be implemented using any combination of discrete circuitry, application specific integrated circuits (ASICs), logic gates and/or single chip architectures. Further, the features of apparatus 500 may be implemented using microcontrollers, programmable logic arrays and/or microprocessors or any combination of the foregoing where suitably appropriate (collectively or individually referred to as “logic”).

It should be appreciated that the example apparatus 500 represents only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless mesh network, the method comprising:
determining a next hop node having a lowest sum of cost metrics associated with communicating between a wireless node and a destination along two or more potential multi-hop paths, wherein a cost metric is based on a channel characteristic between each adjacent wireless node in each potential multi-hop path; and
updating a routing table in the wireless node to identify the determined next hop node.

2. The method of claim 1 wherein the cost metric is proportionate to a transmission rate possible in a wireless channel between the adjacent wireless nodes.

3. The method of claim 1 further comprising sending indicia of the lowest sum of cost metrics to each adjacent wireless node, if any, in a direction of a source node.

4. The method of claim 1 wherein updating the routing table further comprises recording the lowest sum of cost metrics associated with communicating via the next hop node.

5. The method of claim 3 wherein the source node comprises an infrastructure-type base station, the wireless node comprises a fixed wireless mesh point and the destination node comprises a mobile station.

6. The method of claim 1 wherein the wireless mesh network comprises a broadband wireless network.

7. The method of claim 1 wherein the potential multi-hop paths are limited to a band of nodes in a trellis between a source and the destination and wherein paths between non-adjacent nodes are ignored.

8. A method of communicating in a wireless mesh network, the method comprising:
routing a communication received at a wireless node to a destination node via one of at least two next adjacent wireless nodes in two or more potential multi-hop paths to the destination node, wherein the one next adjacent node is determined by the wireless node to be on a multi-hop path with a greatest potential transmission rate to the destination node.

9. The method of claim 8 further comprising updating a routing table in the wireless node to reflect the determined one next adjacent node on the multi-hop path with a greatest potential transmission rate to the destination node and to reflect a cost metric associated with communicating via the multi-hop path.

10. The method of claim 8 further comprising sending indicia of the cost metric to one or more adjacent nodes, if any, in a direction towards a source node.

11. The method of claim 10 wherein the two or more potential multi-hop paths are limited to a plurality of wireless nodes specified by the source node.

12. A wireless device comprising:
a processing circuit including logic to determine a next hop node from nodes in one of least two potential multi-hop paths for routing a wireless communication to a destination node, wherein the next hop node is determined to be on a multi-hop path having a greatest potential transmission rate to the destination node.

13. The wireless device of claim 12 wherein the logic comprises a wireless mesh routing manager.

14. The wireless device of claim 12 wherein the logic further updates a routing table of the wireless device to associate the destination node with the determined next hop node and a cost metric related to communicating along the multi-hop path to the destination node.

15. The wireless device of claim 14 wherein the processing circuit further includes logic to send indicia of the cost metric to one or more adjacent wireless nodes upstream from the destination node.

16. The wireless device of claim 12 wherein the device comprises one of a macro base station or a micro base station.

17. The wireless device of claim 12 wherein the device further comprises a radio frequency (RF) interface in communication with the processing circuit.

18. A wireless system comprising:
a processing circuit including logic to determine a next hop node in two or more potential multi-hop paths for routing a wireless communication to a destination node, wherein the next hop node is determined to be on a multi-hop path having a lowest cost metric associated with communicating to the destination node;
a radio frequency (RF) interface communicatively coupled to the processing circuit; and
at least two antennas coupled to the RF interface for at least one of multiple input or multiple output communication.

19. The system of claim 18 wherein the logic uses a Viterbi algorithm to determine the next hop node.

20. The system of claim 18 wherein the lowest cost metric is inversely proportional to a rate of transmission achievable between each node in the two or more potential multi-hop paths.

21. The system of claim 18 wherein the logic further updates a routing table to associate the destination node with the determined next hop node and a cost metric related to communicating along the multi-hop path to the destination node.

22. The system of claim 18 wherein the system comprises a broadband wireless base station.
